(19) United States
(12) Patent Application Publication
(10) Pub. No.: US 2026/0288492 A1
(43) Pub. Date: Sep. 24, 2026

(54) SYSTEM AND METHOD OF DYNAMIC USER INTERFACE MODULATION SYSTEM BASED ON BIOMETRIC VARIANCE AND REAL-TIME COGNITIVE RESILIENCE VIA TRIADIC GOVERNANCE

(71) Applicant: Shamsi Sanati Monfared, Lake Forest, CA (US)

(72) Inventor: Shamsi Sanati Monfared, Lake Forest, CA (US)

(21) Appl. No.: 19/567,130

(22) Filed: Mar. 14, 2026

Related U.S. Application Data
(60) Provisional application No. 63/774,063, filed on Mar. 18, 2025.

(51) Int. Cl. G06F 9/451; G06F 3/01; G10L 15/02

(52) U.S. Cl. CPC G06F 9/451; G06F 3/013; G10L 15/02

(57) ABSTRACT

A computer-implemented system and method for real-time adaptive interface modulation and closed-loop user state synchronization. The system employs a multi-layered state machine architecture comprising a Sequential Processing Logic Layer modeled as a seven-state transition pipeline, Variable Data Layers for monitoring physiological variance and behavioral syntax, and a Triadic Governance Logic involving an Autonomous Agent, a User Node, and a Supervisor Node. The system continuously ingests asynchronous telemetry to detect “Performance Asymptotes” (Heuristic Locks) and “Input Divergences.” Upon detection, the system injects a “Signal Injection Artifact” (e.g., visual occlusion or temporal acceleration) into the user interface to force a logic state transition. The governance logic operates on a weighted consensus protocol, transitioning from supervisor-validated control to fully autonomous adaptive control based on a calculated correlation coefficient.

### CROSS REFERENCE TO RELATED APPLICATIONS

This application claims the benefit of priority under 35 U.S.C. § 119(e) to U.S. Provisional Patent Application No. 63/774,063, filed on Mar. 18, 2025, entitled “EricSyn: Adaptive Decision Training System,” the entire contents of which are hereby incorporated by reference.

### BACKGROUND OF THE INVENTION

### 1. Field of the Invention

The present disclosure relates generally to adaptive human-computer interaction (HCl) systems and closed-loop control logic. More specifically, it relates to a computer-implemented architecture for processing asynchronous multimodal biometric data streams to generate real-time state vectors of a user and dynamically modulating a graphical user interface (GUI) or haptic feedback device via a multi-node governance protocol involving automated algorithms and validated expert inputs.

### 2. Description of Related Art

In complex computational environments such as aviation cockpit displays, robotic surgical consoles, and tactical command interfaces, the efficiency of the human-machine loop is critical. These systems typically present high-density data streams to a user who must process information and execute inputs under strict temporal constraints. However, conventional user interfaces are “static”; they render information at a constant density and refresh rate regardless of the user's physiological capacity to ingest that data. When a user experiences high cognitive load or physiological arousal (e.g., tachycardia or saccadic gaze instability), the static interface can induce “cognitive tunneling,” resulting in a desynchronization between the system's data presentation and the user's processing bandwidth.

Current adaptive training and simulation technologies fail to address this real-time desynchronization. Conventional approaches generally fall into two categories: (a) Linear Scripting Engines, utilized in standard flight simulators, which adjust difficulty based solely on task completion metrics (e.g., did the user crash?) rather than the user's internal processing state; and (b) Generic Biometric Monitoring, which may record heart rate or eye movement but lacks the computational logic to correlate these biological signals with specific decision-making stages. Consequently, these systems operate on “lagging indicators”, detecting failure only after it has occurred, rather than predicting and preventing “input anomalies” before they manifest as operational errors.

Furthermore, existing automated instructional systems (Intelligent Tutoring Systems) suffer from significant “signal interpretation errors.” While machine learning algorithms can ingest biometric data, they often lack the contextual ground-truth data required to distinguish between a user's momentary distraction and a critical processing freeze. Purely automated interventions frequently result in “false positives,” triggering interface changes that disrupt the user unnecessarily. Conversely, purely human-guided instruction suffers from “detection latency,” where an instructor cannot perceive micro-expressions or biometric shifts fast enough to intervene in real-time. There remains a critical need for a hybrid governance architecture that can fuse high-speed biometric processing with validated expert logic to dynamically modulate interface complexity and maintain optimal human-machine data synchronization.

### SUMMARY OF THE INVENTION

The present invention addresses the limitations of the prior art by providing a computer-implemented system and method for Real-Time Adaptive Interface Modulation (hereinafter “the System”). The System utilizes a multi-layered processing architecture (referred to conceptually as the “3-2-7 Framework”) to digitize operator performance states, enabling the predictive detection of input anomalies and the automated reconfiguration of a user interface to maintain system-user synchronization.

In one aspect, the invention comprises a Fixed Processing Layer (The “7”) modeled as a “Hierarchical State Machine.” This model maps the user's interaction telemetry to a sequence of seven discrete processing states: (1) Schema/Database Retrieval; (2) Signal Detection and Gaze Fixation; (3) Hypothesis Formulation; (4) Predictive Simulation; (5) Action Selection; (6) Motor Execution; and (7) Error Monitoring. By correlating timestamped user inputs (e.g., eye tracking coordinates, button press latencies) to these specific states, the System isolates the precise node in the decision logic where signal processing has failed (e.g., a “Gaze Fixation” failure manifests as a lack of scanning in the presence of a visual alert).

In another aspect, the invention integrates Two Variable Data Layers (The “2”) comprising a Physiological Metric Module and a Behavioral Syntax Module. Unlike static simulation tools, the present invention continuously ingests asynchronous biometric data streams (e.g., Electrocardiogram (ECG) variance, saccadic velocity, and voice pitch frequency) to generate a real-time “Physiological State Vector.” This allows the System to algorithmically distinguish between a “Performance Plateau” (characterized by low biometric variance and high accuracy) and a “Processing Divergence” (characterized by high biometric variance and input latency), thereby determining the appropriate interface modulation protocol.

In a further aspect, the invention employs a Triadic Governance Logic (The “3”) to execute intervention commands. This module operates as a “Weighted Consensus Protocol” between three nodes: the User (via bio-feedback), an Autonomous Agent (AI), and a Human Supervisor. The System utilizes a “Dynamic Confidence Threshold”: initially, the AI generates candidate interface modifications that require a validation bit from the Human Supervisor (Human-in-the-Loop); the system calculates a running accuracy score for the AI based on the frequency of human overrides. As the accuracy score exceeds a pre-defined confidence threshold, the System progressively shifts the validation authority to the AI, enabling autonomous real-time operation.

The technical effect of the invention is the dynamic transformation of the Graphical User Interface (GUI) or control environment. When a “Performance Plateau” is detected, the System generates a “Structured Perturbation Artifact”, such as a pixel-based visual occlusion mask, a temporal acceleration of data rendering, or a haptic noise signal, and injects it directly into the display pipeline. This injection forces the user to switch from heuristic (automatic) processing to algorithmic (deliberate) processing, thereby recalibrating the user's error monitoring capabilities in real-time.

### DESCRIPTION OF DRAWINGS

FIG. 1 illustrates a high-level system architecture of a closed-loop biometric feedback control system “100” configured for dynamic interface modulation and user state synchronization. The system “100” comprises a Real-World Telemetry Node “102” (for capturing baseline data) and a Synthetic Environment Rendering Node “104” (for simulation and training), both communicatively coupled to a central Cloud-Based Biometric Processing Core “106” via a secure low-latency network.

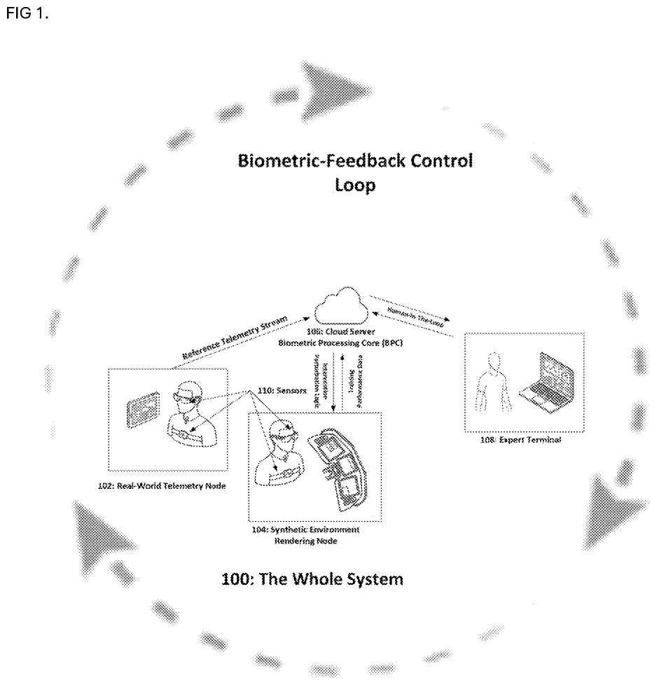

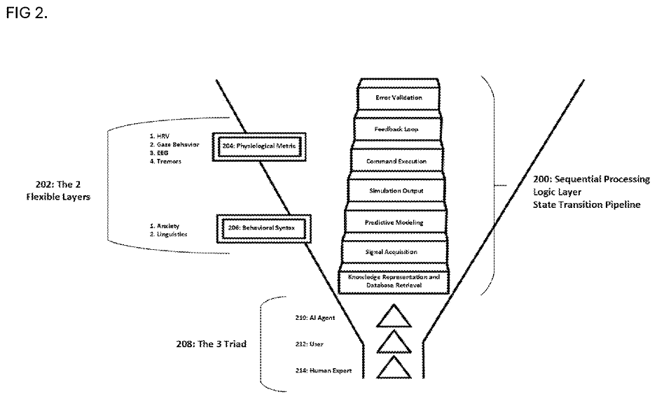

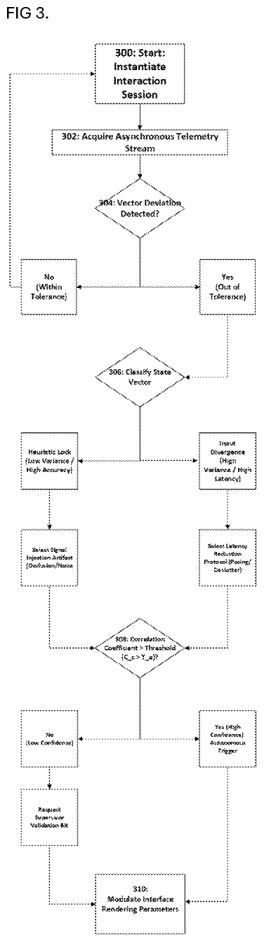

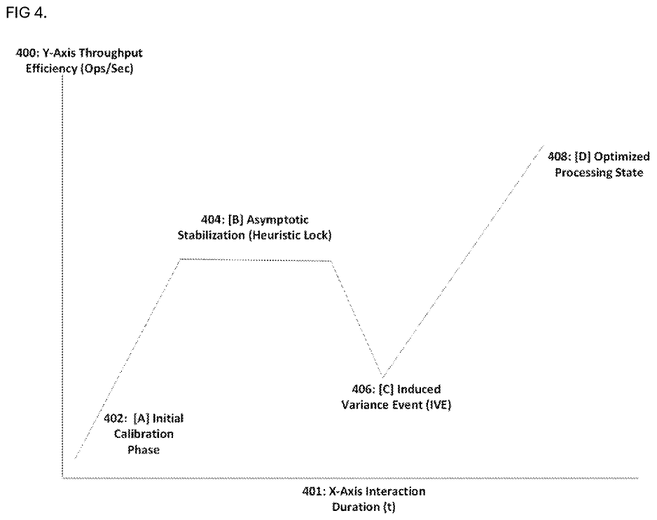

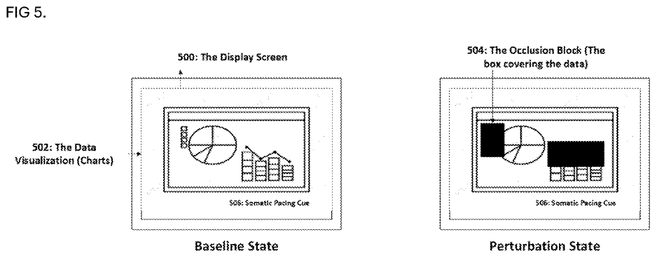

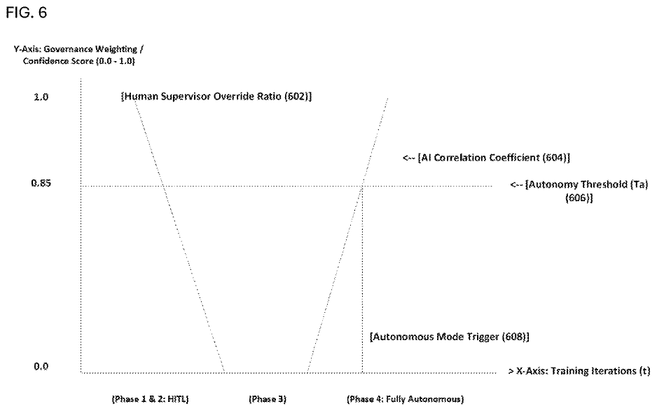

As shown, the user interacts with a plurality of multimodal sensors “110” (e.g., eye-tracking optical sensors, haptic feedback vests, electrodermal activity straps, EEG, etc.) configured to capture asynchronous physiological and behavioral signals. In the Real-World Telemetry Node “102”, these sensors “110” transmit a continuous stream of “Ground Truth” data, labeled as the Reference Telemetry Stream, to the Processing Core “106”. This data aggregation establishes a quantitative “Optimal Performance Baseline” (OPB) for the specific user.

The Processing Core “106” executes a fusion algorithm on this data to generate a real-time “Biometric State Vector.” When the user engages with the Synthetic Environment Node “104” (e.g., a VR simulation or screen-based task), the Core “106” transmits Interface Control Commands downwards. These commands inject “Structured Perturbation Artifacts” (e.g., visual occlusion masks or input lag) into the simulation logic. Simultaneously, the system facilitates a Triadic Governance Loop via an Expert Terminal “108”. This terminal renders the user's biometric vector visually and accepts “Validation Signals” from a human supervisor (Human-in-the-Loop), which update the weighting parameters of the AI's autonomous decision logic over time.

FIG. 2 is a schematic diagram illustrating the multi-layered state processing architecture utilized by the Biometric Processing Core “106”. The architecture is organized into three interacting data processing subsystems, designated as the “3-2-7” configuration:
(a) Central to the architecture is the Sequential Processing Logic Layer “200”, depicted as a “State Transition Pipeline.” This layer maps the user's interaction telemetry to a hierarchical sequence of seven predefined logic states: (1) Knowledge Representation and Database Retrieval (validating schema access); (2) Signal Acquisition (verifying sensory registration); (3) Predictive Modeling (generating candidate action paths); (4) Simulation Output (forecasting results); (5) Command Execution (committing the decision); (6) Feedback Loop (monitoring system response); and (7) Error Validation (comparing outcome to prediction). The system is configured to detect a “Processing Latency Exception” when the data stream fails to transition from a lower state (e.g., Signal Acquisition) to a higher state (e.g., Predictive Modeling) within a set interval.
(b) Flanking the Logic Layer “200” are The 2 Flexible Layers “202”, which function as variable data ingestion buffers. These include a Physiological Metric Module “204” and a Behavioral Syntax Module “206”. Physiological Module “204” aggregates asynchronous biometric signals including Heart Rate Variability (HRV), Gaze Behavior, Electroencephalography (EEG), and Micro-tremors to generate a somatic variance vector. The Behavioral Module “206” aggregates interaction patterns such as Self-Reported Anxiety indices and Linguistic Syntax markers to generate a cognitive load vector.
(c) Supporting the entire architecture is The 3 Triad “208”, functioning as the foundational governance logic. This module comprises three consensus nodes: the AI Agent “210”, the User Node “212”, and the Human Expert Node “214”. As illustrated, the Triad “208” operates as a “Weighted Consensus Protocol,” determining when to inject a structured perturbation into the Logic Layer “200” based on the convergence or divergence of data from the Flexible Layers “202”.

FIG. 3 is a logic flowchart illustrating the computer-implemented method “300” for real-time adaptive interface control and progressive autonomy. The method initiates at step “300”, where the system instantiates an interaction session (e.g., a simulation environment or live monitoring feed).

At step “302”, the system ingests a continuous stream of asynchronous data, including physiological signals (derived from the Variable Layers 202, 204, such as HRV variance and gaze velocity) and interaction metrics (e.g., input latency, error frequency). At decision block “304”, the Core Processing Unit compares this real-time vector against a stored “Reference Performance Model.” If the user's vector remains within the calculated optimal range (‘No’), the system loops back to monitoring. If a vector deviation is detected (‘Yes’), the logic proceeds to decision block “306” to classify the processing state. This classification distinguishes between two distinct “Non-Optimal State” definitions:
(a) A “Heuristic Lock”, characterized by low physiological variance and high task accuracy, indicating a lack of processing demand. In this state, the system selects a “Signal Injection Artifact” (e.g., pixel occlusion, temporal acceleration, or noise injection) to force a state transition.
(b) An “Input Divergence”, characterized by high physiological variance (arousal) and high input latency. In this state, the system selects a “Latency Reduction Protocol” (e.g., a pacing cue, interface decluttering, or a ‘Reset Trigger’) to restore signal synchronization.

Once the intervention protocol is selected, the system proceeds to the Validation Logic Gate at decision block “308”. Here, the system executes a Probability Matching Routine. The processor calculates a Correlation Coefficient (C_c) representing the statistical probability that the selected intervention matches the historical intervention data for the current biometric profile.

The system compares the calculated Coefficient (C_c) against a pre-determined Autonomy Threshold (T_a) (e.g., 0.85):
(a) If C_c>T_a (High Confidence): The correlation is statistically significant. The system determines that the calculated protocol is reliable and proceeds to Autonomous Execution (Step 316) without external validation.
(b) If C_c<T_a (Low Confidence): The data is ambiguous or the vector is novel. The system blocks autonomous execution and routes the command to Step “314”, triggering a “Validation Request” on the Supervisor Terminal “108”. The Supervisor must manually transmit a validation bit to authorize the intervention.

Finally, at step “310”, the system executes the intervention by dynamically modulating the rendering parameters of the user interface, thereby altering the information processing load on the user in real-time.

FIG. 4 is a graphical representation of the System Throughput Optimization Curve facilitated by the present invention. The graph plots Throughput Efficiency “400” (vertical axis), defined as correct decisions per unit of time, against Interaction Duration “401” (horizontal axis).

Asymptotic Stabilization: As illustrated, the system initially records a phase of Initial Calibration “402”, where efficiency metrics improve rapidly. However, without the intervention of the present system, the user inevitably reaches a Performance Asymptote “404”. In this state, the user relies on low-variance heuristic processing rather than high-variance algorithmic processing. The Biometric Processing Core “106” detects this asymptote “404” by identifying a stabilization in physiological variance (e.g., a reduction in HRV standard deviation below a threshold) and a cessation of error rates, indicating a lack of processing demand.

Induced Variance Event (IVE): Upon detection of the asymptote “404”, the Governance Logic executes a “Signal Injection Protocol.” This causes a temporary Efficiency Dip “406”, also referred to as the “Recalibration Interval.” This dip “406” is an intentional feature of the control loop, not a failure. By injecting noise (e.g., via Visual Occlusion “504”), the system disrupts the user's reliance on heuristic shortcuts, forcing a return to explicit Error Validation (State 7) protocols.

Optimized Processing State: Following the induced variance event “406”, the system enters a recovery phase leading to an Optimized Processing State “408”. In this final state, the user's throughput exceeds the previous asymptote “404”, demonstrating that the system has successfully recalibrated the user's processing bandwidth to accommodate higher data complexity.

FIG. 5 is a schematic representation of the Adaptive GUI “500” shown in two distinct operational modes: a Standard Rendering Mode (Left) and a Modulated Rendering Mode (Right). The GUI “500” may be embodied as a standard monitor, a tablet display, a Heads-Up Display (HUD) in an aviation cockpit, or a Virtual Reality (VR) headset view.

Standard Rendering Mode: In this mode, the interface displays a plurality of Telemetry Visualizations “502”, such as flight data, medical vitals, or tactical maps. In this state, the system logic assumes the user is operating in State 2 (Signal Acquisition), relying on external visual scanning. The Biometric Processing Core “106” monitors the user's gaze coordinates and saccadic velocity to verify “Gaze Fixation Stability.”

The Occlusion Mask Artifact: Upon detecting a “Heuristic Lock” (as described in FIG. 4), the Processing Core triggers a Signal Injection Protocol. As illustrated in the Modulated Mode (Right), the system dynamically generates a Visual Occlusion Mask Artifact “504”. This artifact is a pixel layer superimposed over a specific coordinate region of the Telemetry Visualizations “502”, effectively removing external data availability.

State Transition Logic: This occlusion is not a rendering error but a calculated “Data Obfuscation Event.” By removing the visual input stream, the system compels the user's processing logic to transition from External Signal Acquisition (State 2) to Internal Predictive Modeling (State 4). This forced transition disrupts the “Heuristic Lock,” requiring the user to generate simulation outputs based on cached memory rather than live visual feed.

Bio-Sync Pacing Artifact: Simultaneously, or alternatively, if the system detects an “Input Divergence” (e.g., HRV variance exceeding a safety threshold), the interface renders a Bio-Sync Pacing Artifact “506”. As shown in FIG. 5, this may appear as a rhythmic oscillating bar, a pulsing chromatic overlay, or a haptic vibration signal.

Closed-Loop Regulation: The Bio-Sync Artifact “506” oscillates at a specific frequency (e.g., 0.1 Hz) to drive “Biometric Entrainment” (synchronizing the user's autonomic nervous system to the visual signal). The system monitors the user's Biometric State Vector in real-time; once the vector returns to the “Reference Performance Model” boundaries, the system automatically terminates the Occlusion Mask “504” and the Bio-Sync Artifact “506”, restoring the interface to the Standard Rendering Mode.

FIG. 6 is a graphical representation of the “Autonomy Transfer Function” utilized by the Triadic Governance Logic. The graph plots the Control Authority Weighting (vertical axis) against System Training Iterations (horizontal axis).

Two inverse trends are depicted: The Supervisor Override Ratio “602” (representing human corrections) begins at a maximum value during the “Supervised Learning Phase.” Conversely, the AI Correlation Coefficient “604” begins at a minimum. As the system processes more “Ground Truth” data from the expert, the Coefficient “604” ascends.

The logic defines a critical Autonomy Threshold (T_a) “606” (e.g., 0.85). When the AI Correlation Coefficient “604” exceeds this threshold, the system triggers a “Governance Handoff,” formally transitioning from “Human-in-the-Loop” validation to “Fully Autonomous Adaptive Control,” thereby minimizing system latency.

### DETAILED DESCRIPTION OF THE LOGIC

### The Multi-Layered State Machine Architecture (The Core Engine)

Referring now to FIG. 2, the Biometric Processing Core 106 operates on a multi-layered state processing architecture referred to herein as the “3-2-7 Configuration.” This architecture integrates three distinct data processing layers to digitize, predict, and remediate user input anomalies in real-time.

The Sequential Processing Logic Layer (The “7”): The central pillar of the architecture is the Logic Layer “200”, modeled as a “State Transition Pipeline.” Unlike prior art systems that treat user input as a monolithic event, the present invention dissects the interaction stream into a hierarchical sequence of seven predefined logic states:
(1) Knowledge Representation and Database Retrieval: The access of stored schema data from memory.
(2) Signal Acquisition: The registration of mission-critical interface elements (verified via gaze fixation coordinates).
(3) Predictive Modeling: The formulation of candidate command sequences based on retrieved schemas.
(4) Simulation Output: The forecasting of system state changes prior to execution.
(5) Command Execution: The commitment of a specific input signal (e.g., button press).
(6) Feedback Loop: The monitoring of system response to the input.
(7) Error Validation: The comparison of the actual system state against the predicted state.

Diagnostic Logic of the Processing Layer: The Core Engine “106” maps every timestamped user interaction (e.g., dwell time, verbal response latency, error syntax) to one of these seven states. For example, if a user's gaze fails to intersect with a flashing alert coordinate (State 2 error), the system categorizes this as a “Signal Acquisition Fault.” If the user intersects the coordinate but inputs an incorrect command (State 5 error), it is categorized as a “Command Execution Fault.” This granularity allows for targeted interface modulations rather than generic warnings.

The Variable Data Layers (The “2”): Flanking the Logic Layer are the Two Variable Layers: the Physiological Metric Module “204” and the Behavioral Syntax Module “206”. The Physiological Module “204” aggregates asynchronous biometric data from sensors “110”, including Heart Rate Variability (HRV), Galvanic Skin Response (GSR), and pupillometry. It quantifies the user's “Autonomic Variance Vector.” The Behavioral Module “206” aggregates interaction data, including self-reported confidence indices and linguistic syntax markers derived from Natural Language Processing (NLP). It quantifies the user's “Cognitive Load Index” (e.g., high load vs. low load).

The Triadic Governance Logic (The “3”): Overseeing the interaction between the Logic and Variable layers is the Triadic Governance Logic, comprising the AI Agent “210”, the User Node “212”, and the Supervisor Node “214” (Human Expert). The module operates on a ‘Weighted Consensus Protocol’ (Claim 6), as graphically depicted in FIG. 6. Initially, the AI Agent “210” functions in “Supervised Learning Mode,” proposing interface modifications that must be validated by the Supervisor Node “214”. The system calculates a “Supervisor Override Ratio,” tracking the frequency with which the Supervisor rejects the AI's proposal. When the AI Correlation Coefficient “604” (FIG. 6) exceeds the Autonomy Threshold (T_a) “606”, indicating high AI accuracy), the system transitions to “Autonomous Mode,” where the AI Agent “210” directly modulates the user interface without validation latency.

### Operation & Intervention Logic

Operational Logic: The Adaptive Control Loop: Referring to FIG. 3, the system executes a continuous loop of Monitoring, Diagnosis, and Intervention. The process begins with Baseline Data Normalization, where the system captures a “Maximum Variance” and “Minimum Variance” dataset to establish the boundaries of the “Reference Performance Model.”

Asymptote Detection and Signal Injection: As illustrated in FIG. 4, a critical function of the system is the detection of “Performance Asymptotes” [404]. The Biometric Processing Core “106” identifies an asymptote when throughput metrics stabilize and biometric variance decreases below a set threshold (indicating low processing load).

In response, the system triggers a “Signal Injection Protocol” (FIG. 3, Step 308). The system dynamically alters the rendering parameters of the Adaptive GUI “500” (FIG. 5) to induce processing load. Examples of injection artifacts include:
(a) Visual Occlusion: Temporarily rendering an opaque mask (Block 504) over critical data fields to force reliance on internal memory buffers (State 1).
(b) Temporal Compression: Accelerating the refresh rate of incoming telemetry to saturate Signal Acquisition bandwidth (State 2).
(c) Noise Injection: Rendering stochastic visual or auditory noise to test Signal-to-Noise Ratio (SNR) filtering.

Latency Detection and Synchronization: Conversely, if the system detects an “Input Divergence” (e.g., HRV variance spike+Gaze Tunneling), it triggers a “Latency Reduction Protocol” (FIG. 3, Step 310). The system modulates the interface to reduce data density (e.g., hiding non-critical layers) and renders a Bio-Sync Pacing Artifact “506” (FIG. 5). This artifact guides the user to synchronize physiological rhythm (e.g., via 0.1 Hz oscillation) to restore autonomic equilibrium before returning to full data density.

The Prediction Error Validation Loop: To ensure long-term model accuracy, the system enforces a “Validation Checksum” (Claim 21). Before revealing the outcome of a simulation event (e.g., “Target Hit/Miss”), the system pauses and prompts the user to input a “Confidence Bit.” The system compares this subjective bit against the objective outcome. A discrepancy (e.g., High Confidence Bit/Negative Outcome) is flagged as a “Prediction Error Vector,” triggering a specific data review module to recalibrate the user's internal error monitoring logic.

System Configuration Stages: The system “100” is configured to operate through four structured “Algorithmic Weighting Stages,” ensuring a seamless transition from supervised to autonomous operation.

(a) Stage 1: Data Aggregation & Pattern Recognition: In the initial stage, the Processing Core “106” functions primarily as a telemetry recorder. It captures “Reference Stream” data from the Real-World Telemetry Node “102” to build the user's specific “Biometric State Vector.” The system identifies the “Max/Min Variance” boundaries to calibrate the Deviation Detection Logic (FIG. 3, Step “304”).

(b) Stage 2: Supervised Modulation (The Injection Phase): Once the baseline is established, the system enters the Active Modulation Phase. Here, the system injects Signal Artifacts (e.g., Occlusion “504”) upon detecting Performance Asymptotes. The Triadic Governance Logic operates in a strict “Supervisor-in-the-Loop” mode, where the AI generates candidate commands, but the Supervisor Node “214” must transmit a validation bit. This ensures that the AI's “Correlation Coefficient” is trained on validated expert data.

(c) Stage 3: Consensus & Weighting Integration: In this stage, the system monitors for “Prediction Alignment.” As the user's Confidence Bit aligns with the AI's objective data, the system reduces the weighting of the Supervisor Node “214”. The AI begins to operate with higher autonomy as its Correlation Coefficient consistently exceeds the threshold T_a.

(d) Stage 4: Autonomous Adaptive Control: In the final stage, the system operates in “Fully Autonomous Mode.” The Supervisor Node “214” is removed from the active control loop, serving only as a passive data logger. The AI Agent “210” dynamically modulates the interface parameters in real-time, effectively functioning as an “Autonomous Adaptive Controller.”

### ALTERNATE EMBODIMENTS

Hardware and Deployment Architectures: While the preferred embodiment utilizes a Virtual Reality (VR) headset and wearable biometric sensors, the invention is not limited to this configuration. The underlying “State Machine Architecture” is hardware-agnostic and may be deployed across various computational environments.

(a) Mobile Computing Embodiment: The system may function as a background process on a mobile device, utilizing the device's integrated front-facing optical sensor for Gaze Tracking and the microphone array for Voice Frequency Modulation Analysis. In this embodiment, the “Structured Perturbation” comprises temporal modulation of the device's screen refresh rate or color saturation levels.

(b) Tactical Heads-Up Display (HUD): The system may be integrated into an aviation or infantry HUD. Here, the “Bio-Sync Artifact 506” is rendered as distinct symbology (e.g., a pulsing reticle) overlaid on the external world view, providing real-time autonomic cues without obstructing the field of view.

(c) Remote Telemetry Embodiment: The Supervisor Terminal “108” may be a cloud-based dashboard, allowing a single Supervisor Node to monitor and validate the “Biometric State Vectors” of multiple remote users simultaneously via a low-latency network connection.

Domain-Specific Integration: The architecture described herein is adaptable for various high-performance environments:
(a) Robotic Surgical Integration: The system integrates with robotic surgical consoles to detect operator fatigue (via Gaze Fixation Drift) and automatically “Declutter” the interface by occluding non-critical telemetry data during high-precision maneuvers (State 6 Execution).
(b) Aviation “Adaptive Co-Pilot”: The system monitors pilot gaze tunneling during critical flight phases (e.g., approach). Upon detecting a “Signal Acquisition Fault” (State 2), the system automatically suppresses non-essential alerts on the Primary Flight Display (PFD) to prioritize critical flight path data.
(c) High-Latency Communication Environments: In dispatch or control room scenarios, the system analyzes voice pitch frequency to detect “Cognitive Load Spikes.” The system then modulates the audio stream (e.g., applying a noise filter or slowing the playback speed) to ensure “Signal Intelligibility” is maintained.

### CONCLUSION & SCOPE

Conclusion: Thus, the present invention provides a robust, scalable system for Real-Time Adaptive Interface Modulation. By integrating the Sequential Processing Logic Layer, Variable Data Layers, and Triadic Governance Logic, the system effectively bridges the gap between static user interfaces and dynamic human processing capabilities. The use of “Structured Signal Injection” to disrupt “Heuristic Locks” represents a significant technical advancement over prior art passive monitoring tools, enabling a truly closed-loop human-machine system.

1. A computer-implemented method for real-time adaptive interface modulation and closed-loop user state synchronization, the method comprising:
(a) receiving, via a Real-World Telemetry Node comprising a plurality of multimodal sensors, a continuous stream of interaction telemetry and asynchronous physiological signals from a user engaged in a computational task;
(b) wherein said interaction telemetry comprises at least one of linguistic syntax patterns, gaze fixation coordinates, and input latency metrics;
(c) generating, by a processor executing a Biometric Processing Core, a real-time Physiological State Vector based on a variance analysis of the asynchronous physiological signals;
(d) correlating the user's interaction telemetry to a Hierarchical State Machine comprising a predefined sequence of logic processing states ranging from Data Retrieval to Error Validation;
(e) detecting a Performance Asymptote by identifying a stabilization of the Physiological State Vector below a variance threshold while task accuracy remains above a performance threshold, indicating a Heuristic Lock;
(f) generating, via a Triadic Governance Logic, a candidate Signal Injection Protocol configured to disrupt the Heuristic Lock, wherein the protocol comprises a command to render a sensory artifact on a user interface;
(g) validating the candidate Signal Injection Protocol against a stored Reference Performance Model; and
(h) executing the validated Signal Injection Protocol by dynamically modulating a rendering parameter of the user interface to alter a signal-to-noise ratio presented to the user.

2. The method of claim 1, wherein the Hierarchical State Machine comprises a seven-state processing sequence consisting of: (1) Database Retrieval, (2) Signal Acquisition, (3) Predictive Modeling, (4) Simulation Output, (5) Command Execution, (6) Feedback Loop, and (7) Error Validation.

3. The method of claim 2, wherein correlating the interaction telemetry comprises detecting a failure in Signal Acquisition (State 2) by analyzing gaze fixation coordinates for a lack of saccadic scanning movement (Tunneling) despite the presence of a visual alert.

4. The method of claim 2, wherein correlating the interaction telemetry comprises detecting a failure in Command Execution (State 5) by identifying a discrepancy between a recognized visual signal and a subsequent motor input.

5. The method of claim 1, wherein the Triadic Governance Logic operates in a Supervised Learning Mode, comprising:
(a) generating, by an Autonomous Agent, the candidate Signal Injection Protocol;
(b) holding the execution of the protocol in a latency buffer;
(c) transmitting a validation request to a remote Supervisor Node; and
(d) executing the protocol only upon receiving a digital validation bit from the Supervisor Node.

6. The method of claim 1, further comprising an Autonomous Handoff Routine, comprising:
(a) calculating a Supervisor Override Ratio representing a frequency of corrective inputs received from a human supervisor node over a defined training interval;
(b) calculating an AI Correlation Coefficient representing a statistical alignment between the Autonomous Agent's candidate protocols and historical supervisor actions;
(c) comparing the AI Correlation Coefficient against a pre-determined Autonomy Threshold (T_a); and
(d) automatically revoking the requirement for human supervisor validation when the AI Correlation Coefficient exceeds the Autonomy Threshold, thereby transitioning the system to a Fully Autonomous Control Mode.

7. The method of claim 1, wherein the physiological signals comprise at least one of: Heart Rate Variability (HRV) standard deviation, Electrodermal Activity (EDA) amplitude, or Pupil Diameter modulation.

8. The method of claim 1, wherein the interaction telemetry comprises Voice Frequency Modulation data, and wherein generating the Physiological State Vector comprises detecting a shift in voice pitch or syntax complexity indicative of a Cognitive Load Spike.

9. The method of claim 1, wherein the Signal Injection Protocol comprises a Visual Occlusion Artifact, wherein the processor commands the user interface to render an opaque pixel mask over a specific coordinate region of the display to force the user to utilize internal Predictive Modeling (State 3).

10. The method of claim 1, wherein the Signal Injection Protocol comprises a Temporal Compression Artifact, wherein the processor accelerates a refresh rate of displayed telemetry data to saturate the user's Signal Acquisition bandwidth.

11. The method of claim 1, further comprising detecting an Input Divergence State characterized by physiological variance exceeding a safety threshold, and responsively executing a Latency Reduction Protocol, wherein the user interface displays a Bio-Sync Pacing Artifact oscillating at a fixed frequency to drive autonomic entrainment.

12. The method of claim 1, further comprising executing a Prediction Error Validation Loop, wherein the system:
(a) pauses the task prior to revealing a result;
(b) prompts the user to input a binary Confidence Bit;
(c) compares the Confidence Bit against an objective outcome; and
(d) flags a Prediction Error Vector if the Confidence Bit is positive while the objective outcome is negative.

13. The method of claim 1, wherein the Reference Performance Model is derived from a repository of ground-truth telemetry data captured from expert operators in a specific domain environment.

14. The method of claim 1, wherein the Real-World Telemetry Node comprises a head-mounted display (HMD) with integrated infrared eye-tracking sensors and a microphone array.

15. The method of claim 1, wherein modulating the rendering parameter comprises altering a contrast ratio or color saturation of the user interface to test Signal Acquisition sensitivity.

16. The method of claim 1, wherein the steps are performed iteratively to create a closed-loop feedback cycle, and wherein the Signal Injection Protocol is dynamically scaled in intensity based on a real-time derivative of the Physiological State Vector.

17. A closed-loop biometric feedback control system for expertise acceleration, comprising:
(a) a Real-World Telemetry Node configured to capture user motor inputs, gaze coordinates, and asynchronous biometric signals during a performance event to establish a Reference Performance Model;
(b) a Synthetic Environment Rendering Node configured to generate a simulated decision-making interface based on the Reference Performance Model;
(c) a Biometric Processing Core communicatively coupled to the Nodes, configured to:
(i) analyze the inputs to identify a Performance Asymptote where task accuracy is high and biometric variance is low; and
(ii) inject Structured Perturbation Artifacts into the Synthetic Environment Rendering Node to force a logic state transition; and
(d) a Supervisor Terminal configured to visualize the user's Physiological State Vector and transmit validation signals to the Processing Core.

18. The system of claim 17, wherein the Supervisor Terminal is configured to visualize a “Governance Weighting Graph” displaying a real-time crossover point between Supervisor Override frequency and AI Confidence.

19. The method of claim 1, wherein the computational task is a simulation of a domain selected from the group consisting of: tactical military command, robotic surgery, aviation piloting, and high-frequency trading.

20. The method of claim 1, further comprising a Calibration Routine, wherein the processor records a “Maximum Variance” dataset and a “Minimum Variance” dataset prior to the task to normalize the Physiological State Vector.
